(19) United States
(12) Patent Application Publication
(10) Pub. No.: US 2015/0240943 A1
(43) Pub. Date: Aug. 27, 2015

(54) REDUCED FRICTION OIL CONTROL PISTON RINGS

(71) Applicant: G.B. Kirby MEACHAM, (US)

(72) Inventor: G. B. Kirby Meacham, Shaker Heights, OH (US)

(21) Appl. No.: 14/432,571

(22) PCT Filed: Sep. 24, 2013
(86) PCT No.: PCT/US2013/061350

§ 371 Date: Mar. 31, 2015

Related U.S. Application Data
(60) Provisional application No. 61/744,553, filed on Sep. 28, 2012.

(51) Int. Cl. F16J 9/20; B23P 15/06; F16J 1/08

(52) U.S. Cl. CPC F16J 9/203; F16J 1/08; B23P 15/06

(57) ABSTRACT

Improved oil control piston rings with reduced friction compared to prior art rings are disclosed for use in liquid lubricated internal combustion engines, gas pumps, and gas compressors. The ring assemblies are interchangeable with conventional oil control rings and offer similar oil control performance. Like conventional oil control rings, they include a spring action expander that loads circular steel scraper rails against the cylinder bore to form a sliding barrier between the oil-filled crankcase and the combustion chamber and pressure sealing piston rings. Unlike conventional rings, the improved ring assemblies utilize means of supporting thinner scraper rails that form the sliding barrier with less contact force and resulting friction.

This application claims the priority of U.S. provisional application 61/744,553.

### FIELD OF THE INVENTION

The present invention is directed to oil control piston rings that form sliding oil barriers in pistons operating in cylindrical bores in liquid lubricated internal combustion engines and reciprocating pumps and compressors.

### BACKGROUND OF THE INVENTION

The oil control piston rings in internal combustion engines are essential to minimizing lubricating oil consumption, but at the same time are a major contributor to engine friction that increases fuel consumption. This is particularly true for light-duty vehicle engines that typically operate at part load where parasitic oil ring friction becomes a larger part of the total engine output. Oil control ring friction consumes an estimated 1 to 3% of engine fuel at full load and 2 to 6% at light load. Two embodiments of the inventive reduced friction oil control piston ring offer a means of reducing friction and resulting fuel consumption without increasing lubricating oil consumption. Both are novel assemblies that incorporate thin, low contact force oil scraper rails to reduce friction while retaining oil control performance. One is a five-piece assembly similar in many respects to conventional three-piece oil control rings which have a formed sheet metal spring expander and are used predominantly in light-duty reciprocating pistons. The second is also a five-piece assembly similar in many respects to two-piece oil control rings which have a wire helical spring expander that are used predominantly in heavy-duty applications. Fuel saving are expected to provide a quick payback of the cost of the additional components.

FIGS. 1 and 2 show a typical prior art three-piece oil control piston ring assembly 100. It is installed in a groove 101 in a piston 102 below the two compression ring grooves 103 and 104 containing compression rings 108 and 109, and is made up of two split circular steel scraper rails 105 spring-loaded against the cylinder bore 106 by an expander 107 through multiple contact points 115. The expander also separates the two scraper rails and positions the rails so that they are in sliding contact with the upper and lower piston groove surfaces 116 and 117. The expander 107 functions as a circumferential compression spring with a free diameter larger than the installed diameter. When the ring assembly 100 is compressed to the bore diameter, the scraper rings 105 circumferentially compress the expander 107 to the installed diameter, resulting in an outward radial force transferred from the expander 107 to the scraper rails 105, urging them into tight contact with the bore 106. The scraper rails are flexible in the radial direction and the radial expander force is set high enough that the scraper rails will conform to minor cylinder bore distortions.

As the piston 102 reciprocates (downward motion 110 shown) in the bore 106, the scraper rails 105 remove most of the oil 111 on the cylinder bore and return it to the crankcase, leaving a thin film (not shown) to lubricate the upper portion of the piston and the compression rings 108 and 109. Oil 112 collected between the two scraper rails 105 is returned to the crankcase through oil drain holes 113 connecting the oil ring piston groove 101 to the inside of the piston 102. The contact area between a scraper rail 105 and the cylinder bore 106 acts as an oil-lubricated slider bearing, where the thickness of the oil film in the bearing zone is a major factor in determining the thickness of the oil film left on the cylinder bore surface. In this hydrodynamic mode the ring acts as a linear slider bearing of the type described in the Standard Handbook for Mechanical Engineers, 7th Edition, edited by Theodore Baumeister. Page 8-171 (1960) published by the McGraw-Hill Book Company, New York. This lubrication theory indicates that the slider bearing oil film thickness hₒ is:

$${h}_{o} ∝ L \sqrt{\frac{μ υ C}{W}}$$

where L is the bearing contact zone width, μ is the oil viscosity, v is the sliding velocity, C is the bearing zone circumference and W is the total radial force on the bearing zone. Oil film thickness therefore decreases with a narrower contact zone or a higher radial force. Higher radial force, however, increases the friction force given by:

F∝\sqrt{WμνC}

These equations show that a narrow ring with a low radial force is the lowest friction means of producing a given oil film thickness. There are limits, however, to how much the scraper rail bearing contact zone width and radial force in conventional three-piece oil control rings can be reduced. The scraper rails 105 must be thick enough to withstand the axial friction loads without excessive axial deflection in the unsupported bridge areas between expander 107 contact points, limiting how thin the rails can be. The outside diameter 114 of a standard thickness scraper rail can be beveled or profiled to form a narrower bearing contact zone to allow reduced radial force and friction, but this approach has drawbacks. The bearing zone width will tend to increase with ring wear, increasing the oil film thickness and oil consumption. Also, the scraper rail radial stiffness will not decrease in proportion to the reduced contact zone width and radial force. This limits the ability of the ring to conform to cylinder bore distortion, increasing oil film thickness and consumption in portions of the rail circumference having reduced contact force.

FIGS. 3 and 4 show a typical prior art two-piece oil control piston ring assembly 300. It functions in much the same way as the three-piece rings described above, but has higher flexibility and wear tolerance making it more suitable for heavy duty applications requiring long service life. It is installed in a groove 101 in a piston 102 below the two compression ring grooves 103 and 104 containing compression rings 108 and 109, and is made up of a split circular scraper ring 301 spring-loaded against the cylinder bore 106 by a helical expander spring 302. The scraper ring 301 is in sliding contact with the upper and lower piston groove surfaces 116 and 117, and incorporates an integral upper scraper 303 and lower scraper 304 separated by a groove 305. Radial oil return slots 306 connect the groove 305 to the inner surface 307 of the scraper ring. The expander spring 302 is a circumferential compression spring with a free diameter larger than the installed diameter. When the ring assembly 300 is compressed to the bore diameter, the scraper ring 301 circumferentially compresses the expander spring 302 to the installed diameter, resulting in an outward radial force transferred from the expander spring to the scraper ring 301, urging the scrapers 303 and 304 into tight contact with the bore 106. The scraper ring 301 is flexible in the radial direction and the expander spring force is set high enough that the scrapers will conform to minor cylinder bore distortions and maintain oil control.

As with three-piece rings, there are limits to how much the width of the scrapers 303 and 304 contact zones and radial force in conventional two-piece oil control rings can be reduced. The scrapers 303 and 304 must be thick enough to withstand the axial friction loads without excessive bending stress and with a radial extent sufficient to allow for wear over the service life of the ring. The outside diameter of standard thickness scrapers rail can be beveled or profiled to form a narrower bearing contact zone to allow reduced radial force and friction, but this approach has drawbacks. The bearing zone width will tend to increase with ring wear, increasing the oil film thickness and oil consumption.

### SUMMARY OF THE INVENTION

The proposed reduced friction oil control piston rings combine a narrow contact zone that is insensitive to wear with the radial flexibility to conform to cylinder bore distortion with reduced radial force. Like conventional control rings, they are installed in a piston groove below the two compression ring grooves and include a spring action expander. The difference is that the two individual circular steel scraper rails in three piece rings or the integral scrapers of two-piece rings are replaced by thin, flat scraper rail rings. The expander circumferential spring tension is reduced to provide the required oil film thickness with the thin scraper rails, thereby reducing ring friction while remaining flexible enough to conform to cylinder bore distortions. Additional elements are added to the ring assemblies to support the thin scraper rings. The first embodiment is a five-piece assembly in which the thin scraper rails are spring-loaded against the cylinder bore by the expander and in sliding contact with the adjacent piston groove surface. Thicker support flat rails that are not spring-loaded against the cylinder bore by the expander, and lightly loaded against the cylinder bore by their own elastic tension, are positioned between the scraper rails and the expander. The expander contacts only the sides of the two support rails, and positions them in the axial direction so that they are in sliding contact with the thin scraper rails. Radial clearance is provided between the support rail inside diameter and the expander. The thicker support rails serve to bridge the unsupported areas between expander contact points and prevent excessive deflection of the thin scraper rails caused by axial friction forces. The second embodiment is a five-piece assembly in which the thin scraper rails are spring-loaded against the cylinder bore by a helical coil spring expander acting through an intermediate bridge ring expander. The scraper rails are supported and held in sliding contact with the upper and lower piston groove surfaces by a floating spacer ring that separates the two thin scraper rings. The spacer ring is lightly loaded against the cylinder bore by its own elastic tension, but is not loaded by coil spring expander so it generates little friction. The spacer ring contacts only the sides of the two scraper rails, and supports them against axial friction forces.

### DESCRIPTION OF DRAWINGS

The appended claims set forth those novel features that characterize the invention. However, the invention itself, as well as further objects and advantages thereof, will best be understood by reference to the following detailed description of preferred embodiments. The accompanying drawings, where like reference characters identify like elements throughout the various figures in which:

FIG. 1 illustrates a three-piece prior art oil control piston ring in an internal combustion engine;

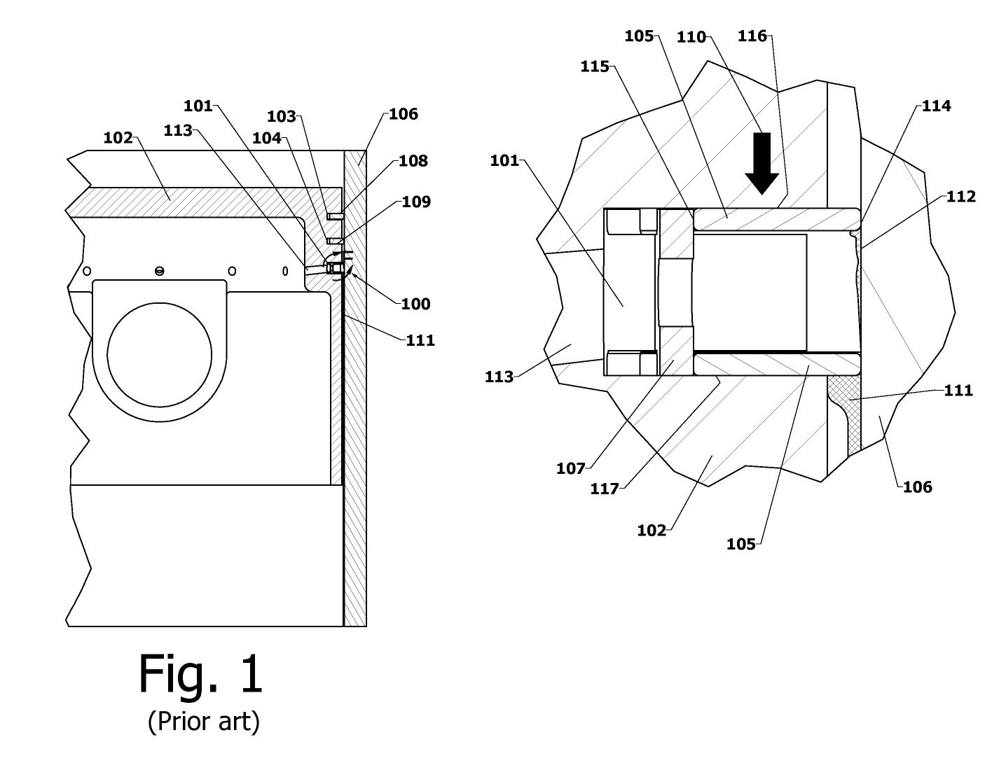

FIG. 2 provides a perspective view of the three-piece prior art oil control piston ring components;

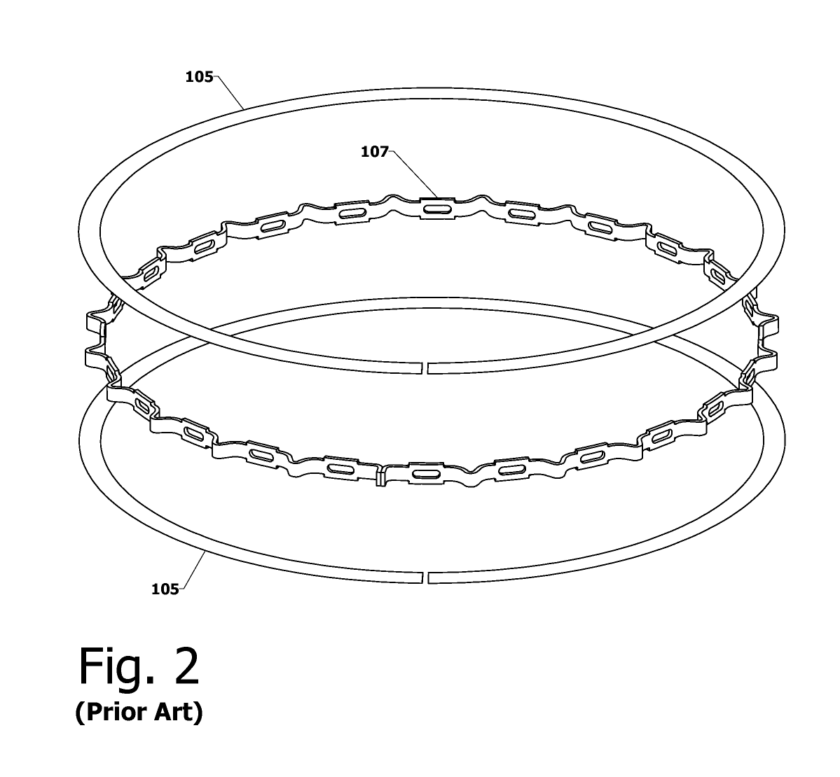

FIG. 3 illustrates a two-piece prior art oil control piston ring in an internal combustion engine;

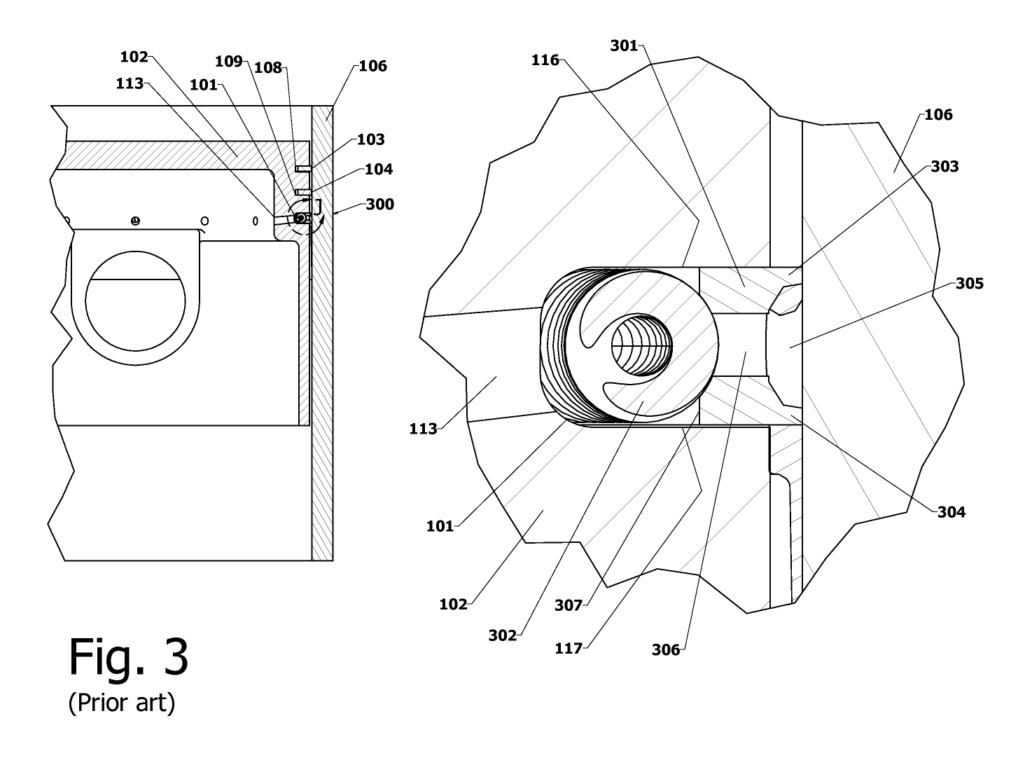

FIG. 4 provides a perspective view of the two-piece prior art oil control piston ring components;

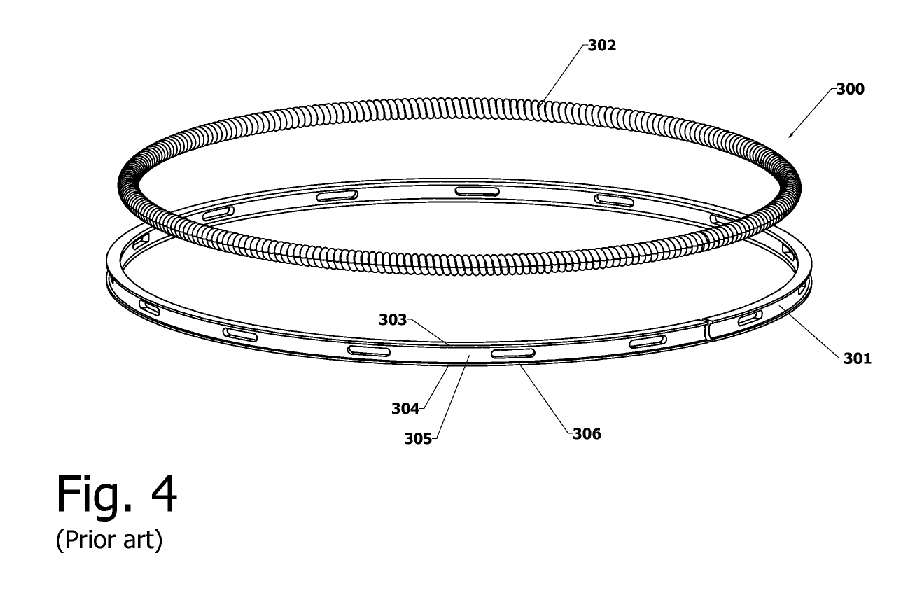

FIG. 5 illustrates a first embodiment of the reduced friction oil control ring according to this invention in an internal combustion engine;

FIG. 6 provides a perspective view of the first embodiment of the reduced friction oil control piston ring components;

FIG. 7 provides a perspective view and details of the first embodiment of the reduced friction oil control piston ring assembly;

FIG. 8 illustrates a second embodiment of the reduced friction oil control ring according to this invention in an internal combustion engine; and

FIG. 9 provides a perspective view of the second embodiment of the reduced friction oil control piston ring components:

### DETAILED DESCRIPTION OF THE INVENTION

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

The prior art and the invention are described with reference to internal combustion engines, but it is to be understood that the invention is applicable to liquid lubricated oil control piston rings in other applications including gas compressors. In the description “upper”, “top”, “above” and “head” refer to the direction towards the combustion chamber, and “lower” and “downward” refer to the direction towards the crankcase.

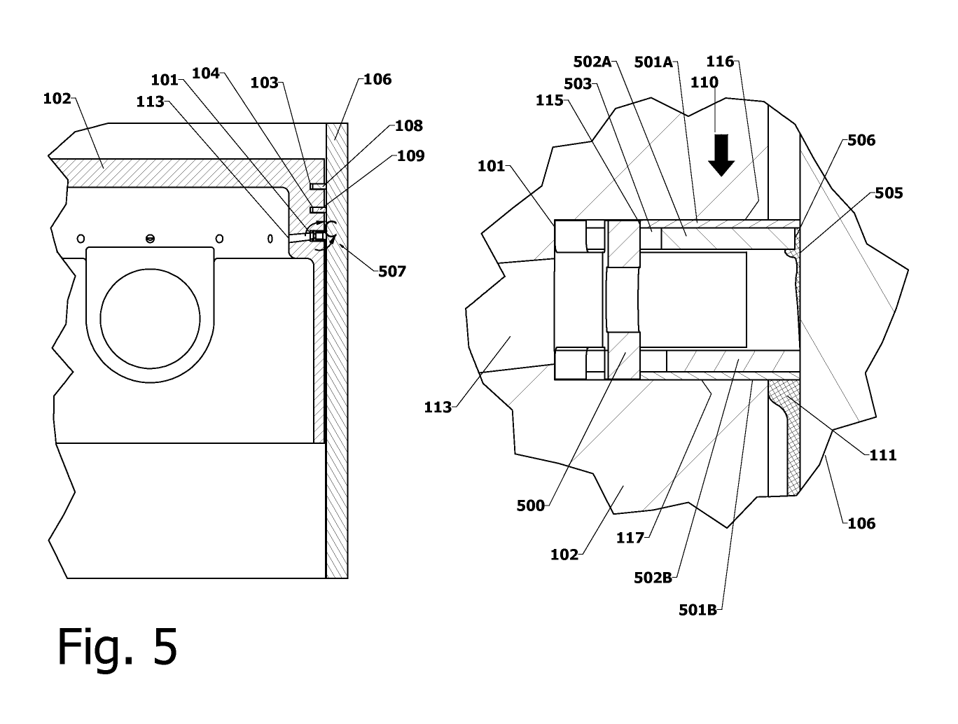

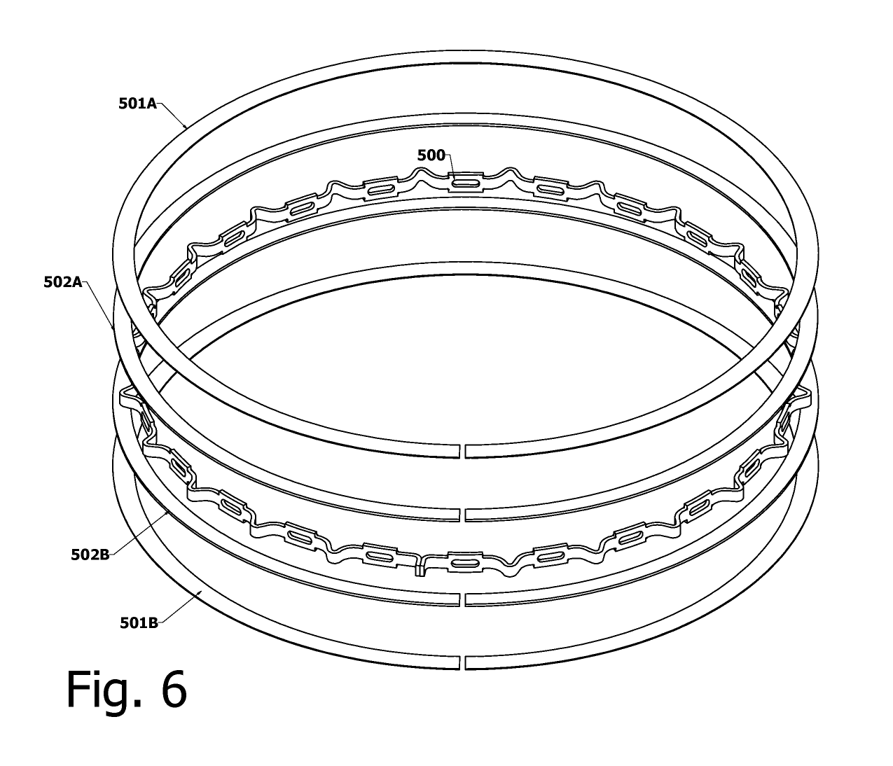

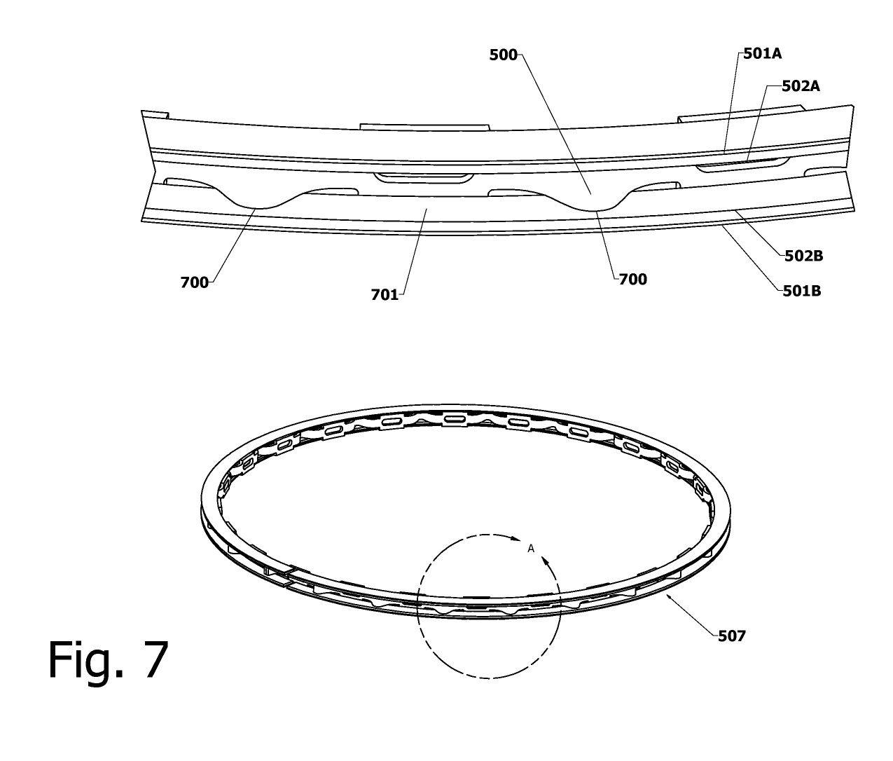

FIG. 5, FIG. 6 and FIG. 7 show the first embodiment of the reduced friction oil control piston ring 507. Like the conventional three-piece oil control ring, this five-piece ring is installed in a piston groove 101 below the two compression ring grooves 103 and 104 containing compression rings 108 and 109, and includes a spring action expander 500. The difference is that the two circular steel scraper rails 105 are each replaced by a pair of rails. The outer rails 501 in each pair are thin scraper rails spring-loaded against the cylinder bore 106 by the expander 500 through multiple contact points 115 and in sliding contact with the adjacent upper and lower surfaces 116 and 117 of piston groove 101. The inner rail 502 in each pair is a thicker support rail that has a radial clearance 503 with the expander 500 so that rail 502 is not spring-loaded against the cylinder bore 106 by the expander, and lightly loaded against the cylinder bore by its own elastic tension. The expander 500 contacts only the sides of the two support rails 502 at multiple points, and positions them in the axial direction so that they are in sliding contact with the thin scraper rails. As shown in FIG. 7, the thicker support rails 502 serve to bridge the unsupported areas 701 of the thin scraper rails 501 between expander contact points 700 and prevent excessive axial deflection of the thin scraper rails caused by frictional forces between the scraper rails and the cylinder bore 106. The expander 500 circumferential spring tension is reduced to provide the required oil film thickness with the thin scraper rails 501, thereby reducing ring friction. The light radial loads on the support rails 502 minimize their contribution to friction.

The scraper rails 501 are supported on one side by the upper and lower piston groove surfaces 116 and 117 of piston groove 101 and on the other side by a thicker support rail 502, and therefore may be very thin and still withstand the axial friction loads and loads imposed by radial expander 500. Axial clearances are set such that the scraper rails 501 are free to slide radially relative to the support rails 502 and the piston groove surfaces 116 and 117. Similarly, the support rails are free to slide radially relative to the expander and the scraper rails. Oil control performance is maintained over the life of the ring assembly, since scraper rail 501 wear does not affect the width of the slider bearing zone. The radial stiffness of the thin scraper rail 501 decreases in proportion to the decreased bearing zone width and reduced radial force. This characteristic allows it to retain the ability of conventional three-piece ring assemblies to conform to cylinder bore distortions, but with reduced radial force and friction.

The trailing support rail 502A is pushed radially inward by the oil 505 collected by the adjacent trailing scraper rail 501A, and forms a dynamic gap 506 with the cylinder bore 106 that allows the oil to flow to the piston groove drain holes 113. This dynamic gap is shown for the down-stroke in FIG. 5, and is larger than the oil film thickness in the scraper rails 501 slider bearing zones because of the low outward radial force of the support rail 502. The leading support rail 502B is not pushed in, and slides on the thin oil film left by the leading scraper rail 501B.

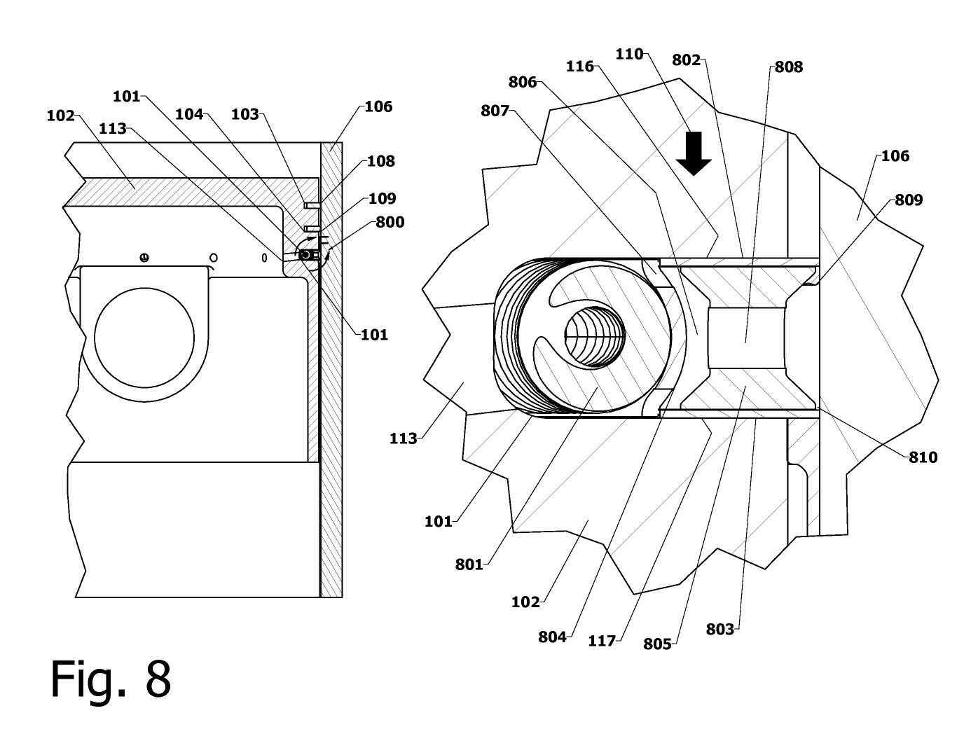

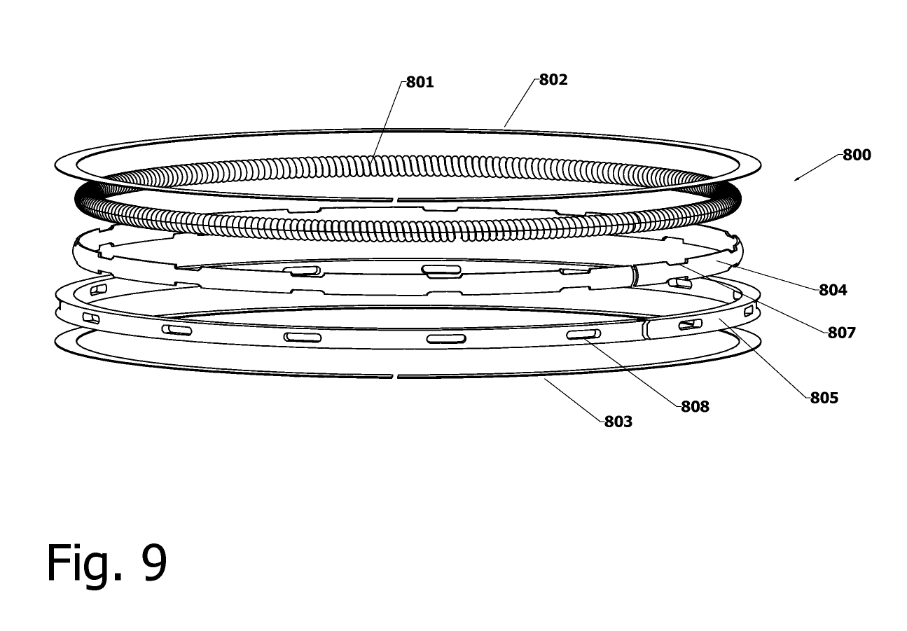

FIG. 8 and FIG. 9 show the second embodiment of the reduced friction oil control piston ring 800. Like conventional two-piece oil control rings, this five-piece ring is installed in a piston groove 101 below the two compression ring grooves 103 and 104 containing compression rings 108 and 109, and includes a helical spring expander 801. The difference is that the pairs of circular steel scrapers 303 and 304 are each replaced by thin, flat scraper rails 802 and 803. These thin scraper rails are spring-loaded against the cylinder bore 106 by the expander 801 through an intermediate bridge ring 804. The expander 801 exerts an outward radial force on the inside diameter of the bridge ring 804, which in turn exerts an outward radial force on the inside diameters of the scraper rails. The bridge ring is thin in the radial direction, making it radially flexible along its circumferential extent so that it has a small effect on the distribution of force transferred from the expander 801 to the scraper rings 802 and 803. A spacer ring 805 separates the scraper rings 802 and 803, and keeps them in in sliding contact with the upper and lower surfaces 116 and 117 of piston groove 101. The spacer ring 805 has a radial clearance 806 with the bridge ring 804 so that the spacer ring is not spring-loaded against the cylinder bore 106 by the expander 801, and lightly loaded against the cylinder bore by its own elastic tension. The bridge ring 804 and the spacer ring 805 incorporate openings to facilitate oil flow from the annular volume between the scraper rails 802 and 803 to the inner diameter of the piston groove 101 and back to the crankcase through the piston oil drain holes 113. The bridge ring 804 includes edge notches 807 and the spacer ring 805 includes radial slots 808 to provide these functions, but it is obvious that holes or other geometric features could provide similar functions. The expander spring 801 circumferential spring tension is reduced to provide the required oil film thickness with the thin scraper rails 802 and 803, thereby reducing ring friction. The light elastic radial self-loading of the spacer ring 805 minimizes its contribution to friction.

The net effect is the same as in the first embodiment: The scraper rails 802 and 803 are supported on one side by the upper and lower surfaces 116 and 117 of piston groove 101, and on the other side by the spacer ring 805, allowing the scrapers to be very thin and still withstand the axial friction loads and imposed radial loads. Axial clearances are set such that the scraper rails 802 and 803 are free to slide radially relative to the spacer ring and the piston groove. Similarly, the spacer ring position is independent of the bridge ring 804. Oil control performance is maintained over the life of the ring assembly, since wear of the scraper rails 802 and 803 does not affect the width of the slider bearing zone. The radial stiffness of the thin scraper rails 802 and 803 decreases in proportion to the decreased bearing zone width and reduced radial force. This characteristic allows it to retain the ability of conventional two-piece ring assemblies to conform to cylinder bore distortions, but with reduced radial force and friction.

As with the support rails 502, the spacer ring 805 is pushed radially inward by the oil 809 collected by the adjacent trailing scraper rail 802, and forms a dynamic gap 810 with the cylinder bore 106 that allows the oil to flow to the piston groove drain holes 113. This dynamic gap is shown for the down-stroke 110 in FIG. 8, and is larger than the oil film thickness in the scraper rails 802 and 803 slider bearing zones because of the low outward radial force of the spacer ring 805.

1. A liquid lubricant seal for internal combustion engines, gas pumps and gas compressors for use in a piston; wherein the seal is diametrically expandable multiple component ring assembly, and comprises an outside diameter, an inside diameter, and upper and lower faces substantially perpendicular to the piston ring axis;
the piston has an annular ring groove comprising an upper flank, a lower flank and a bottom, and the piston is reciprocally moveable in a bore;
the seal ring assembly is disposed in the ring groove such that the outside diameter of the seal assembly is in sliding contact with the cylinder bore surface, the inside diameter is spaced away from the groove bottom, and the seal assembly upper and lower faces are adjacent the upper and lower groove flanks respectively; and
the seal assembly comprising at least one thin annular scraper ring with a first flank surface in sliding contact with an adjacent piston groove flank, an annular spring means applying an outward radial force to the scraper ring distributed around the circumference of the inner ring diameter, and at least one support ring providing substantially uninterrupted axial contact with the second scraper ring flank surface such that the first scraper ring is supported in the axial direction and the first flank surface is maintained in sliding contact with the adjacent piston groove flank.

2. The liquid lubricant seal assembly according to claim 1 wherein the radial force applied by the annular spring means to the thin annular scraper ring is sufficient to reduce the liquid lubricant film thickness on the bore surface and conform to distortions in the nominally cylindrical bore.

3. The liquid lubricant seal assembly according to claim 1 wherein the support ring has no substantial radial force transmitting connection with the scraper ring or the annular spring means, and has low inherent spring tension such that its radial contact force with the bore surface is significantly less than that of the scraper ring.

4. The liquid lubricant seal assembly according to claim 1 wherein one thin scraper ring is adjacent to the upper piston groove flank and one thin scraper ring is adjacent to the lower piston groove flank, and at least one fluid passage on the piston connects the groove bottom to the lower side of the piston.

5. The liquid lubricant seal assembly according to claim 4 wherein the annular spring means is a formed sheet metal expander of generally conventional configuration;
one of two support rings is located between the upper scraper ring and the expander and the other support ring is located between the lower scraper ring and the expander;
the expander applies outward radial load to the inner diameter of each scraper ring; and
wherein the dimensions of the expander and the support rings are selected such that there is no radial contact and force transmission between the expander and the support rings.

6. The liquid lubricant seal assembly according to claim 5 wherein the support rings are thicker than the scraper rings.

7. The liquid lubricant seal assembly according to claim 4 wherein the annular spring means is a coiled wire spring expander of generally conventional configuration;
a metal bridge ring extends axially between the upper piston groove flank and the lower piston groove flank and contacts the inside diameter of each scraper ring;
the coiled wire spring expander contacts the bridge ring and urges it radially outward, transferring outward radial load to the inner diameter of each scraper ring;
a spacer support ring extends axially between the lower scraper ring and the upper scraper ring; and
wherein the dimensions of the spacer support ring, the scraper rings and the bridge ring are selected such that there is no radial contact and force transmission between the bridge ring and the spacer support ring.

8. The liquid lubricant seal assembly according to claim 7 wherein the spacer support ring includes at least one radial fluid passage connecting the inside and the outside ring diameters.

9. A method for providing a reduced friction sliding scraper liquid lubricant piston bore seal comprising:
replace thick unified liquid scrapers that can carry both radial scraping loads and axial friction loads with a thin scraper cooperating with robust members that support the thin scraper and permit it to carry the axial friction loads;
apply a reduced radial load to the thin scraper commensurate with its reduced width and stiffness to obtain the required liquid film thickness with reduced axial friction; and
adjust the radial forces on the robust support members such that they maintain a range of positions that support the thin scraper rails while creating only a small amount of axial friction with the bore.
